(19) United States
(12) Patent Application Publication
(10) Pub. No.: US 2022/0197412 A1
(43) Pub. Date: Jun. 23, 2022

(54) Input device, input method

(71) Applicant: Yuhei Akatsuka, Matsumoto (JP)

(72) Inventor: Yuhei Akatsuka, Matsumoto (JP)

(21) Appl. No.: 17/131,895

(22) Filed: Dec. 23, 2020

Related U.S. Application Data
(63) Continuation of application No. 62/953,555, filed on Dec. 25, 2019.

(51) Int. Cl. G06F 3/0354; G06F 3/01

(52) U.S. Cl. CPC G06F 3/03547; G06F 3/016

(57) ABSTRACT

This document describes about input device or input method. Input device or input method includes capacitive touch sensor to detect touch input by hand or finger. The touch sensor can detect touch input directly on the device surface, or through thin materials for clothing. The touch sensor surface that is curved face to generate tactile feeling of the direction of touch input. Input device can generate data, to control connected computing devices. Due to the curved face touch sensor, an operator can perform an intended input even when an input device is placed out of a range of his or her vision. Due to the touch sensor that is able to detect touch input through the materials for clothing, input device may be easily attached to an operators body. The input device may aid users in controlling computing device on active condition such as fitness activity, jogging, cycling, or driving vehicle, activities and works requires physical focus and so forth.

### DESCRIPTION:

### BACKGROUND:

The problem with current input device or input methods is that an operator, operating device having input device, such as touch screen or mechanical button, such as smartphone, during active condition, such as fitness activity, jogging, cycling, or driving vehicle, activities and works requires physical focus and so forth, may have a difficulty to operate the device. The difficulty to perform and intended operation due to the user operation mostly required viewing graphical user interface (GUI) on the display of device, or pushing exact position of button on the device. Even the device equipped with only mechanical button interface may require to push exact position of the device, operator on active condition may have difficulty to perform and intended operation.

These difficulty comes from condition which touch screen or mechanical button interface mostly requires operation by viewing the device, requires to operate exact position by finger, may lead the operator hesitate or miss to perform the desired operation in the described active condition.

Input device or input method means device such as remote controller with mechanical button, remote controller with touchpad, computer keyboard, mouse, trackball, touch pad, display with touch screen, digital pen and so forth.

### SUMMARY:

This document proposes an input device or input method that enables an operator to perform an intended input even when the input device is placed out of a range of operator's vision.

Input device or input method includes touch sensor to detect touch input by hand or finger.

The touch sensor can detect touch input directly on the device surface, or through thin materials for clothing by adjusting its sensitivity.

The touch sensor can be capacitive touch sensor or other available technology such as resistive touch sensor and so forth.

The touch sensor surface that is curved face to generate tactile feeling of the direction of touch input

The touch sensor surface that is wide enough size for finger, that is width or height range from 15 mm to 80 mm.

Input device can generate data, to control connected devices such as computing units, via communication interface.

Due to the curved face touch sensor surface to generate tactile feeling of the direction of touch input, that is wide enough size for finger, an operator can perform an intended input even when an input device is placed out of a range of his or her vision.

Due tho the touch sensor that is able to detect touch input through the materials for clothing, input device may easily attached to an operators body.

The input device may aid users in controlling remote device on active condition such as fitness activity, jogging, cycling, or driving vehicle, activities and works requires physical focus and so forth.

Materials for clothing means materials such as textile or alternative materials of clothes, sports wear, backpacks, hand gloves, pockets and so forth.

This summary is provided to introduce simplified concepts concerning input device or input method, which is further described below in the detailed description.

### BRIEF DESCRIPTION OF THE DRAWINGS:

The drawings illustrate an exemplary embodiment consisting of input device.

FIG. I is a perspective view illustrating an example of an external configuration of a touch input device 100 according to an embodiment of the present disclosure;

FIG. 2 is an exploded perspective view of the touch input device 100 illustrated in FIG. 1;

FIG. 3 is a block diagram illustrating an example of a functional configuration of a touch input device 100;

FIG. 4 is a diagram for describing Assignment Example 1 and 2 of an output value according to a touch operation on a touch input face 101;

FIG. 5 is a diagram for describing an example of the touch input face 101 that is able to detect touch input through this materials for clothing.

### DETAILED DESCRIPTION OF THE EMBODIMENT(S):

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

<1. Configuration of an Input Device>

(1-1. Overview of a Configuration of an Input Device)

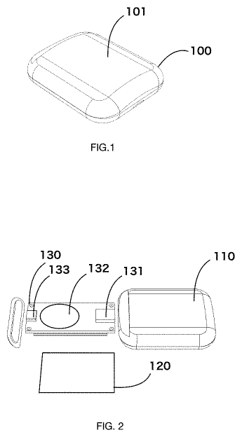

An overview of a configuration example of a touch input device 100 that is an example of an input device according to an embodiment of the present disclosure will be described with reference to FIGS. 1 and 2. FIG. 1 is a perspective diagram illustrating an example of an exterior configuration of the touch input device 100 according to an embodiment of the present disclosure. FIG. 2 is an exploded perspective diagram of the touch input device 100 illustrated in FIG. 1.

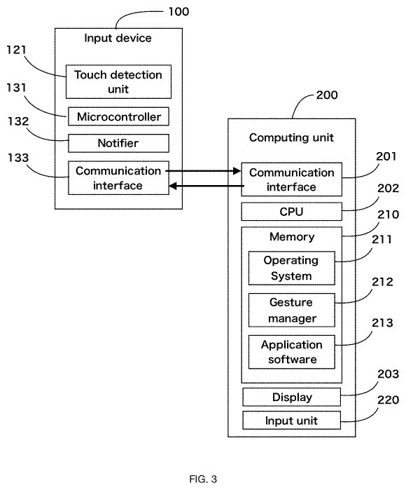

The touch input device 100 is a touch input device with which a user who is an operator can perform input. Using the touch input device 100, the user can operate a computing unit 200 (sec FIG. 3) connected to the touch input device 100. The touch input device 100 is used as, for example, a remote controller, input unit attached to computing unit. The touch input device 100 has a case 110, a touch detection substrate 120, a controller substrate 130, as shown in FIG. 2.

The case 110 constitutes a housing of the touch input device 100. The case 110 has a touch input fact 101 on a surface side on which a user can perform touch operations using his or her finger or hand that is an operating body. The touch input face 101 according to the present embodiment includes curved surface to generate tactile feeling of the direction of touch input.

Here, tactile feeling of the direction are touch feelings in which the user can perceive a direction on the touch input face 101 and an orientation thereof without moving his or her finger. Accordingly, even when the touch input device 100 is placed out of a range of the user's vision, the user can perceive a direction on the touch input face 101, and an input face 101 that is wide enough size for finger, and thus an intended operation can be performed. Touch input face 101 may configured as a single curved face to simplify the tactile feeling of the direction.

The touch detection substrate 120 is a circuit panel that can detect touch operations (for example, contact of a finger) of the user on the flat face 101. The touch detection substrate 120 faces the rear face of the case 110, and is formed following the shape of the touch input face 101.

The controller substrate 130 is a circuit board having a control unit that controls the touch input device 100. The controller substrate 130 is provided in case 110.

(1-2. Functional Configuration of an Input Device) 100291 An example of a functional configuration of the touch input device 100 will be described with reference to FIG. 3. FIG. 3 is a block diagram showing an example of the functional configuration of the touch input device 100. As shown in FIG. 3, the touch input device 100 has a touch detection unit 121, a microcontroller 131, and a notifier 132, and a communication interface 133.

The touch detection unit 121 is provided on the touch detection substrate 120. The touch detection unit 121 has a function of a detection unit that detects operations of a finger of the touch input face 101. The touch detection unit 121 detects positions that come into contact with the finger or hand of the user directly, or through thin materials for clothes, on touch input face 101. And then outputs the detection as contact information to the microcontroller 131.

The microcontroller 131 is a control unit that controls the touch input device 100, and is provided on the controller substrate 130. The microcontroller 131 according to the present embodiment functions as an assignment unit that assigns different output values of touch operations of a finger of the touch input face 101 based on detection results of the touch detection unit 121.

To be specific, the microcontroller 131 assigns, based on the contact information from the touch detection unit 121, output values of contact duration, movement amounts, movement speeds, and movement directions of a finger of the user, the number and the positions of the finger that is in contact or moving. The microcontroller 131 outputs information of the output values corresponding to touch inputs to the communication unit 133.

The notifier 132 is an notification unit to notice operator about input and output status, which microcontroller 131 assigns different output values according to operations of a finger, or which microcontroller 131 receive input values according to outputs information of the output values corresponding to touch inputs to the communication unit 133. Notifier 132 is configured to notice operator about input and output status by light indication or sound indication or vibration or display indication.

The communication unit 133 transmits such output values of touch inputs received from the microcontroller 131 to the computing unit 200 connected to the input device 100. The communication unit 133 receives input values transmitted from the computing unit 200 connected to the input device 100. The communication unit 133 transmits information in a wired or wireless manner.

Herein, a configuration example of the computing unit 200 with which the input device 100 can communicate will be described with reference to FIG. 3. The computing unit 200 has a connection interface 201, a CPU 202, a memory 210, and a display unit 203 that is an example of a display device such as smart phone.

The connection interface 201 receives information of output values of touch inputs from the communication unit 133 of the input device 100. The connection interface 201 transmits information of output values of computing unit 200 to the communication unit 133 of the input device 100. The CPU 202 performs processes of programs stored in the memory 210 based on the information of the output values received from the connection interface 201.

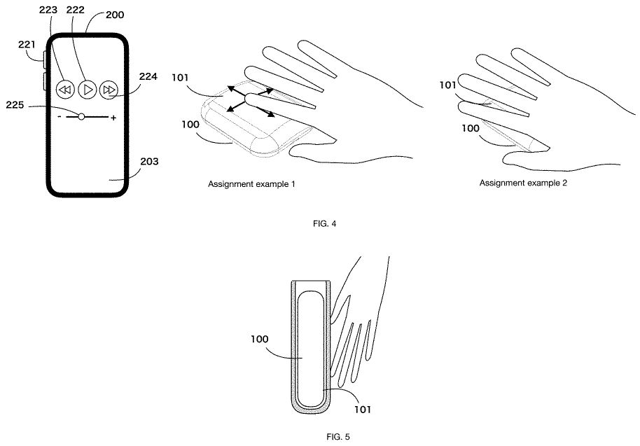

FIG. 4 is a diagram illustrating an example of the microcontroller 131 described above assigns an output value of an operation performed on the input device 100. Accordingly, the user can perform operations of computing unit 200 by performing touch operations of the input device 100 positioned out of a range of his or her vision.

In addition, the microcontroller 131 assigns different output values according to operation directions of a finger in an input region of touch input face 101. Accordingly, a plurality of operations can be performed using one input region.

In addition, the microcontroller 131 assigns different output values according to a multiple finger contact or palm contact in an input region of touch input face 101. Accordingly, a plurality of operations can be performed using one input region.

In addition, the gesture manager 212 assigns different output values and transmits to operating system 211 or application software 213 according to output value of microcontroller 131. Accordingly, a plurality of operations can be performed using one input region. For example, the gesture manager 212 assigns different output values according to locations of the computing unit 200.

In addition, the gesture manager 212 assigns different output values and transmits to the microcontroller 131, then notifier 132, notifying the operator about assignments of different output values assigned by microcontroller 131 or gesture manager 212. For example, the gesture manager 212 assigns sound indication according to output value of microcontroller 131.

The communication unit 133 transmits such output values of touch inputs received from the microcontroller 131 to the computing unit 200 connected to the input device 100. The communication unit 133 transmits information of the output values in a wired or wireless manner.

Herein, a configuration example of the computing unit 200 with which the input device 100 can communicate will be described with reference to FIG. 3. The computing unit 200 has a connection interface 201, a CPU 202, a memory 210, and a display 203 that is an example of a display device, input unit 220 such as mechanical switches or touch sensor. The connection interface 201 receives information of output values of touch inputs from the communication unit 133 of the touch input device 100. The CPU 202 performs processes of programs stored in the memory 210 based on the information of the output values received from the connection interface 201 or input unit 220. For example, the CPU 202 performs control of a display 203 and the like based on the information of the output values.

FIG. 4 is a diagram illustrating an example of the display 203 of the computing unit 200. On the display 203 shown in FIG. 4, a plurality of objects are arrayed in a regular order. Here, when the display 203 embodiment consisting a touch panel as an input unit 220, the user can touch and select an object displayed on the display 203. Accordingly, input unit 220 outputs values to operating system 211 or gesture manager 212.

The microcontroller 131 described above assigns an output value of an operation performed on the display 203 as an output value. Accordingly, the user can perform operations on the display 203 by performing touch operations of the input device 100 positioned out of a range of his or her vision without viewing the display 203.

FIG. 4 is a diagram illustrating an assignment examples of output values of touch operations on the touch input face 101. In Assignment example 1, it is assumed that a user performs a touch operation using the touch input device 100 in vertical, or horizontal direction. To be specific, the user moves his or her finger or fingers in upper vertical direction, microcontroller 131 or gesture manager 212 assigns volume up output value, associated with mechanical button 221 or object 225 on the display 203, the user moves his or her finger in left horizontal direction, microcontroller 131 or gesture manager 212 assigns next track output value, associated with object 224 on the display 203, and so forth.

An assignment of output value may associated with standard command or API provided by operating system 211 or object on display 203.

In Assignment example 2, it is assumed that a user performs a touch operation using the touch input device 100 in multiple finger contact or palm contact in an input region of touch input face 101. To be specific, the user contact his or her multiple finger or palm, microcontroller 131 or gesture manager 212 assigns play or pause output value, associated with object 222 on the display 203.

An assignment of output value may associated with standard command or API provided by operating system 211 or object on display 203.

FIG. 5 is a diagram illustrating an example of the touch input face 101 that is able to detect touch input through this materials for clothing. Accordingly, input device 100 may be easily attached to an operators body.

<2. Conclusion>

As described above, the touch input device 100 detects operations of an operating body (finger) on the touch input face 101 that is wide enough size for finger, having direction of touch feelings.

In addition, the touch sensor surface 101 that is wide enough size for finger, that is width or height range from 15 mm to 80 mm.

In addition, the touch sensor surface 101 that is curved face to generate tactile feeling of the direction of touch input.

In addition, touch input face 101 that is able to detect touch input through this materials for clothing, input device 100 may be easily attached to an operators body.

In addition, the touch input device 100 or gesture manager 212 assigns different output values according to the operation in each of the input directions and input area based on detection results of the touch detection unit 121.

In the case of the configuration described above, since the user can perceive direction on the touch input face 101 and orientations thereof by performing touch operations in the one input region having direction of touch feelings, even when the touch input device 100 is placed out of a range of the user's vision, intended operations can be performed. Particularly. operation direction can be easily perceived even when the user does not move his or her finger.

Accordingly, touch operations can be easily and reliably executed without the user hesitating to perform a touch operation using the input device 100 and without erroneous inputs or lack of response contrary to an intended input.

Furthermore, by assigning different output values according to each of the finger directions and multiple finger or palm area, more operations with respect to the touch input face 101 than in the related art can be assigned.

Additionally, the present technology may also be configured as below:

(1) Au input device or input method including,

a detection unit configured to detect an operation of an operating body in the input region;

an input face that is wide enough size for finger, in which it is possible to operate touch operations, can be easily and reliably execute intended operations, that is width or height range from 15 mm to 80 mm;

an input face including a single curved face, having direction of tactile feeling;

an assignment unit configured to assign different output values according to operations of the operating body in each direction or area of the input region based on detection results of the detection unit;

(2)The input device or input method according to (1), wherein the direction of tactile feeling is tactile feeling in which it is possible to perceive a direction on the input face and an orientation without a movement of the operating body made by an operator.

(3)The input device or input method according to (1) or (2), wherein the input face that is able to detect touch input through the materials for clothing, that is easily attached to an operators body.

What is claimed is:

1. An input device or input method comprising:
an input face including a single curved face, having direction of tactile feeling, wherein the direction of tactile feeling is tactile feeling in which it is possible to perceive a direction on the input face and an orientation without a movement of the operating body made by an operator;
a detection unit configured to detect an operation of an operating body in the input region;
an input face that is wide enough size for finger, in which it is possible to operate touch operations, can be easily and reliably execute intended operations, that is width or height range from 15 mm to 80 mm;
an assignment unit configured to assign different output values according to operations of the operating body in each direction or area of the input region based on detection results of the detection unit;

2. An input device or input method comprising:
an input face including a single curved face, having direction of tactile feeling, wherein the direction of tactile feeling is tactile feeling in which it is possible to perceive a direction on the input face and an orientation without a movement of the operating body made by an operator;
a detection unit configured to detect an operation of an operating body in the input region;
an input face that is wide enough size for finger, in which it is possible to operate touch operations, can be easily and reliably execute intended operations, that is width or height range from 15 mm to 80 mm, an input face that is able to detect touch input through the materials for clothing, that is easily attached to an operators body;
an assignment unit configured to assign different output values according to operations of the operating body in each direction or area of the input region based on detection results of the detection unit;
